(19) United States
(12) Patent Application Publication
(10) Pub. No.: US 2011/0080663 A1
(43) Pub. Date: Apr. 7, 2011

(54) ADAPTIVE LASER BEAM SHAPING

(76) Inventors: Muzammil Arshad Arain, San Jose, CA (US); Rodica Mirela Martin, Gainesville, FL (US); Guido Mueller, Newberry, FL (US); Volke Marcel Quetschke, Brownsville, TX (US); David Howard Reitze, Gainesville, FL (US); David Burnham Tanner, Gainesville, FL (US); Luke Fraser Williams, Gainesville, FL (US)

(21) Appl. No.: 12/995,566

(22) PCT Filed: Aug. 4, 2009
(86) PCT No.: PCT/US09/52681

§ 371 Date: Dec. 1, 2010

Related U.S. Application Data
(60) Provisional application No. 61/086,661, filed on Aug. 6, 2008.

(51) Int. Cl. G02B 27/09; G02B 7/185; G02B 7/02

(52) U.S. Cl. 359/820; 359/896; 359/846

(57) ABSTRACT

Provided is an adaptive device for shaping a laser beam. The adaptive device includes a variable optical configuration. The variable optical configuration includes: an optical element and a temperature element in contact with the optical element. The adaptive device further includes a controller operatively coupled to the temperature element to apply at least one of heating and cooling to the optical element so as to alter a temperature profile of the optical element, thereby causing an optical property change thereof.

### CROSS-REFERENCE TO RELATED APPLICATION

This application claims priority to copending U.S. Provisional Application entitled, “Adaptive Optical Elements for Laser Beam Shaping,” having Ser. No. 61/086,661, filed Aug. 6, 2008, which is incorporated herein by reference in its entirety.

### STATEMENT REGARDING FEDERALLY SPONSORED RESEARCH

This disclosure was made with United States Government support under PHY-0555453 and PHY-0354999 awarded by the National Science Foundation. The United States Government has certain rights in any patent that issues from the present application.

### BACKGROUND

Lasers are becoming more powerful, and controlling the laser beam profile is turning out to be increasingly difficult. For example, in high power systems, power absorption in optical elements may distort the laser beam shape and degrade the quality of the laser beam. Conventional systems for controlling laser beam profile use passive optical elements that either need moving elements to provide active control or require redesigning of the beam shaping elements or the active optical elements are limited to low laser power.

### BRIEF DESCRIPTION OF DRAWINGS

Many aspects of the present disclosure can be better understood with reference to the following drawings. The components in the drawings are not necessarily drawn to scale, emphasis instead being placed upon clearly illustrating the principles of the disclosure. Moreover, in the drawings, like reference numerals designate corresponding parts through the several views.

FIG. 1 is a cross-sectional view of an example of a variable optical configuration including an reflective optical element according to one embodiment of the present disclosure;

FIG. 2 is a cross-sectional view of an example of a variable optical configuration including a refractive optical element according to one embodiment of the present disclosure;

FIG. 3 is a cross-sectional view of an example of a variable optical configuration in combination with another optical element according to one embodiment of the present disclosure;

FIGS. 4A-4D are schematic views of variable optical configurations (as viewed along an axis of the optical element) having various arrangements of heating elements according to various embodiments of the present disclosure;

FIG. 5 is a block diagram of a control system for a variable optical configuration according to one embodiment of the present disclosure;

FIG. 6 is a flowchart that provides one example of a method for adaptively shaping a laser beam according to one embodiment of the present disclosure;

FIG. 7 is a simulated temperature profile of the optical element of the variable optical configuration of the embodiment illustrated in FIG. 4B; and

FIG. 8 is a simulated temperature profile of the optical element of the variable optical configuration of the embodiment illustrated in FIG. 4A.

### DETAILED DESCRIPTION

The following discussion describes systems, devices, methods and other applications of adaptive laser beam shaping according to various embodiments. To this end, adaptive laser beam shaping is provided through controlled thermal lensing in the optical elements. The adaptive laser beam shaping described herein is particularly useful in laser applications requiring high-power laser beams such as material processing (e.g., drilling holes, welding, material cutting, etc.), laser interferometers for gravitational wave observation, high power laser systems, and potentially other applications.

Typically, an optical element can be used for directing an optical beam, such as a laser beam. However, when the laser beam is incident on the optical element, the optical element absorbs some of the power of the laser beam, which causes the optical element to have a non-uniform spatial heat distribution. The non-uniform spatial heat distribution then causes the physical surface profile and the refractive index of the optical element to change. Even a weakly-absorbing optical element may experience such changes when subjected to a high-power Gaussian laser beam (≧100 W) or other high-power light sources.

The dominant effects of this power absorption are surface deformation, governed by the coefficient of thermal expansion, and changes in refractive index, depending upon the thermo-optic coefficient. These effects may create substantial thermal aberrations (i.e., spatially variable optical path-length change) in the laser beam. Hence, this effect is termed “thermal lensing.” The focal length (or the radius of curvature) of the lens varies according to the geometry and physical properties of the material, the temperature profile, and the incident laser beam. This behavior is typically modeled by introducing imaginary lenses at the surface and in the substrate. Since the thermoelastic coefficient, the photoelastic effect, and other effects are relatively small for most optical materials, they are neglected.

Additionally, the non-normal incidence components like beam splitters, Brewster windows, and mirrors introducing astigmatism distort the direct laser beam. These distortions in turn decrease the efficiency of the system by scattering the light into higher order Gaussian modes.

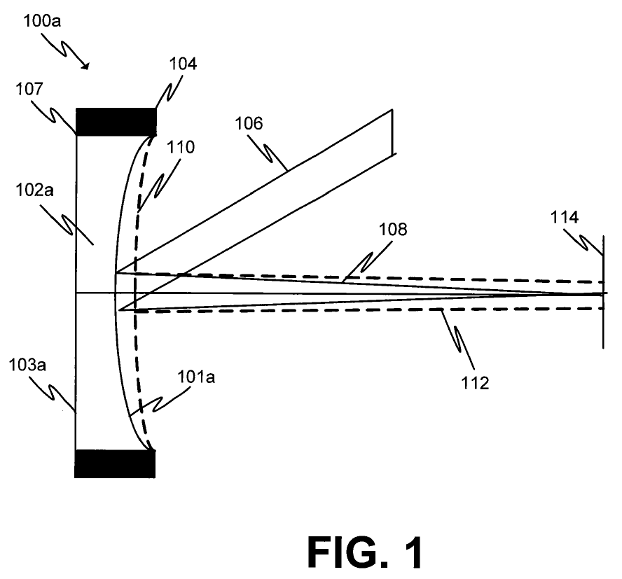

The systems, devices, methods, and other applications of adaptive laser beam shaping described herein address the thermally-induced issues associated with power absorption due to the incident laser beam. Additionally, the systems, devices, methods, and other applications of adaptive laser beam shaping described herein can be used independently to change the shape of the laser beam. In the following paragraphs, various variable optical configurations 100 will be discussed with reference to FIGS. 1, 2, 3, 4A, 4B, 4C, 4D and 5. Each variable optical configuration 100 includes an optical element 102 and a temperature element 104, which includes a heating element and/or a cooling element. In some embodiments, the temperature element 104 may include, as nonlimiting examples, an electric heater, a ring heater, a ceramic heater, a metal layer coupled to a power source, a polymide heater, a silicone rubber heater, a thermoelectric cooler, and/or a Peltier cooler.

Referring now to FIG. 1, shown is a cross-sectional view of one example of a variable optical configuration 100, denoted herein as variable optical configuration 100a. The variable optical configuration 100a includes a reflective optical element 102a, such as a mirror, and a temperature element 104 in conductive thermal contact with the reflective optical element 102a. In some embodiments, the temperature element 104 is provided in direct contact with the reflective optical element 102a. The temperature element 104 may be affixed to the periphery 107 of the reflective optical element 102a in a permanent or temporary manner by any means known in the art. The temperature element 104 may also be affixed to the front surface 101a or the back surface 103a of the optical element 102a. In some embodiments, the optical element 102a includes a metal substrate having an optical coating deposited thereon.

As illustrated in FIG. 1, an input laser beam 106, such as a laser beam, is incident on a surface of the reflective optical element 102a. The beam 106 is reflected by the surface of the reflective optical element 102a so as to be focused as output laser beam 108 onto a focal plane 114. To effect a change in focal length, the reflective optical element 102a may be heated by the temperature element 104a, thereby resulting in change in the reflective surface (shown as dotted line 110). The displaced reflective surface 110 results in the input optical beam 106 being focused as output laser beam 112 onto a different focal plane than focal plane 114. Accordingly, the focal point of the reflective optical element 102a can be changed by a heating of the reflective optical element 102a via the temperature element 104a.

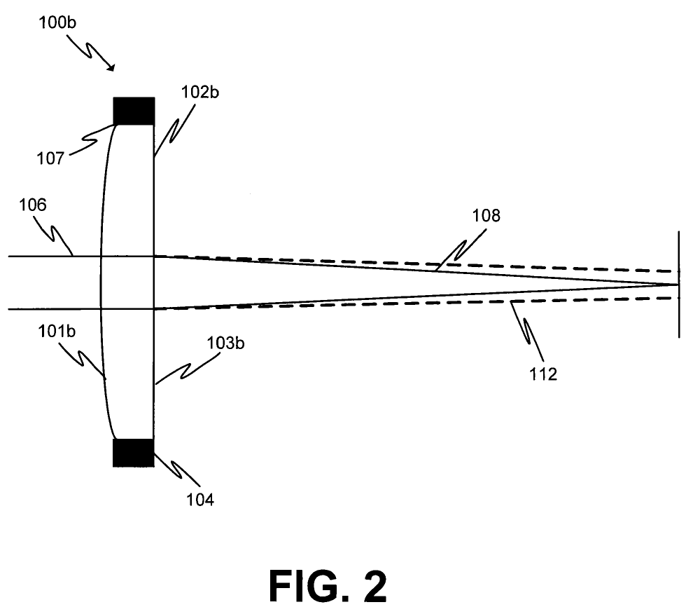

Referring now to FIG. 2, shown is a cross-sectional view of one example of a variable optical configuration 100, denoted herein as optical configuration 100b. The variable optical configuration 100b includes a refractive optical element 102b, such as a lens, and a temperature element 104 (FIG. 1) in conductive thermal contact with the refractive optical element 102b. As in the variable optical configuration 100a, the temperature element 104 is provided in direct contact with the refractive optical element 102b in some embodiments. The temperature element 104 may be affixed to the periphery 107 of the refractive optical element 102b in a permanent or temporary manner by any means known in the art. The temperature element 104 may also be affixed to the front surface 101b or the back surface 103b of the optical element 102.

As illustrated in FIG. 2, an input laser beam 106 is incident on a surface of the refractive optical element 102b. The input laser beam 106 is refracted so as to be focused as output laser beam 108 onto a focal plane. To effect a change in focal length, the refractive optical element 102b may be heated by the temperature element 104, thereby resulting in change in the refractive index of the refractive optical element 102b. The change in the refractive index results in the input laser beam 106 being focused as output laser beam 112 onto a different focal point. Accordingly, the focal point of the refractive optical element 102b can be changed by heating of the refractive optical element 102b.

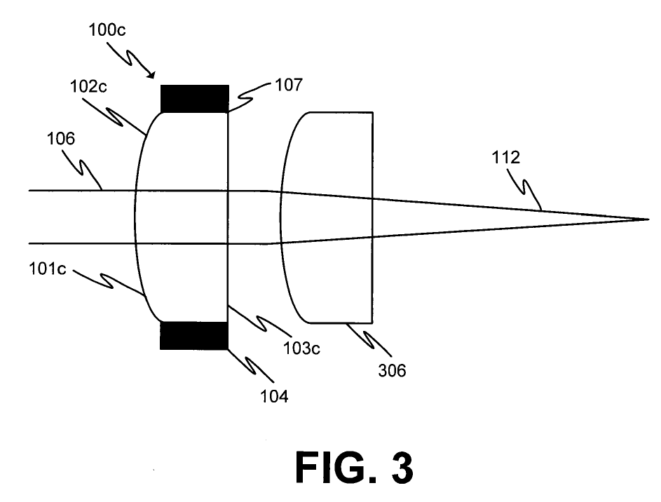

Moving now to FIG. 3, shown is a cross-sectional view of one example of a variable optical configuration 100, denoted herein as optical configuration 100c. The variable optical configuration 100c is in combination with another optical element, such as a Faraday isolator 306. Such a combination may be employed in a laser interferometer for gravitational wave observation, for example. A Faraday isolator 306 is typically used to prevent damage to one or more optical elements 102c and sources of radiation by allowing transmission of light only in one direction by changing the polarization of the beam passing through the Faraday isolator in the reverse direction in conjunction with a polarizer. The main component of the Faraday isolator 306 is a Faraday rotator, which rotates the polarization of input light. In some embodiments, the Faraday isolator 306 is a terbium gallium garnet (TGG) crystal. The Faraday isolator 306, especially TGG, may exhibit a thermo-optic effect that, in a high power optical system, may cause significant aberrations to be introduced into the input laser beam 106.

As a means of compensation for any thermo-optic effects or aberrations, the variable optical configuration 100c includes an optical element 102c that is provided in line with the laser beam passing through the Faraday isolator 306. In this embodiment, the optical element 102c includes a material having negative thermo-optic coefficient, such as hydrated potassium di-deuterium phosphate (DKDP) crystal. Since the TGG crystal has a positive thermo-optic coefficient, the thermo-optic effects or aberrations are corrected by the negative thermo-optic coefficient of the DKDP crystal.

In some embodiments, the optical element 102c has a very high positive thermo-optic coefficient as well as a very large thermal expansion coefficient, relative to the DKDP crystal. For example, SF57, which is a type of glass from SCHOTT™ (Mainz, Germany). Hence, the amount of compensation obtained by a given amount of heat is high. However, the SF57 glass may have a slower response time than the DKDP crystal because the SF57 glass has a relatively low thermal conductivity. In embodiments where the optical element 102c includes SF57, the optical element 102c may be shaped to be reflective, such as the reflective optical element 102a illustrated in FIG. 1, and include a layer of gold on the SF57 to provide a reflective surface on the optical element 102c.

However, the optical element 102c may not completely compensate for thermo-optic effects, aberrations, or other variations in the directed laser beam. The compensation provided by the optical element 102c depends upon the optical power absorbed by the optical element 102c, which in turn depends upon the absorption of the material of the optical element 102c, the absorption of one or more coatings on the optical element 102c, and the thickness of the optical element 102c. In some embodiments, the optical power absorption of the optical element 102c is greater than a certain value (depending upon the absorption of the Faraday isolator 306), the optical element 102c over compensates the aberration in the Faraday isolator 306. When the optical power absorption in the optical element 102c is less than a certain value, the optical element 102c under compensates the aberration in the Faraday isolator 306. As a result, thermal aberrations may continue to propagate through the system even with the optical element 102c.

To further compensate for the uncorrected thermo-optic aberrations, the variable optical configuration 100 also includes a temperature element 104 in conductive thermal contact with optical element 102c. In some embodiments, the temperature element 104 is in direct contact with the optical element 102c. The temperature element 104 may be affixed to the periphery 107 of the optical element 102c in a permanent or temporary manner by any means known in the art. In some embodiments, the temperature element 104 is attached to the front surface 101c or the back surface 103c of the optical element 102c in such a way that the optical element 102c does not obscure the input laser beam 106 passing through the optical element 102c. An input laser beam is incident on a surface of the optical element 102c. By applying heating or cooling to the optical element 102c via the temperature element 104, any remaining thermal aberrations may be corrected.

Further, the application of heat at the periphery 107 may mitigate overcompensation in the optical element 102c produced by the self absorption of the optical element 102c. Applying cooling via the temperature element 104 may mitigate the undercompensation of the optical element 102c through the self absorption. Thus, by combining the self absorption of the optical element 102c and the applied heating or cooling via the temperature element 104, the input laser beam 106 can be adaptively shaped. Similarly, in embodiments where the optical element 102c includes SF57 glass having a reflective geometry, the heating and cooling via the temperature element 104 can mitigate the undercompensation and overcompensation, respectively.

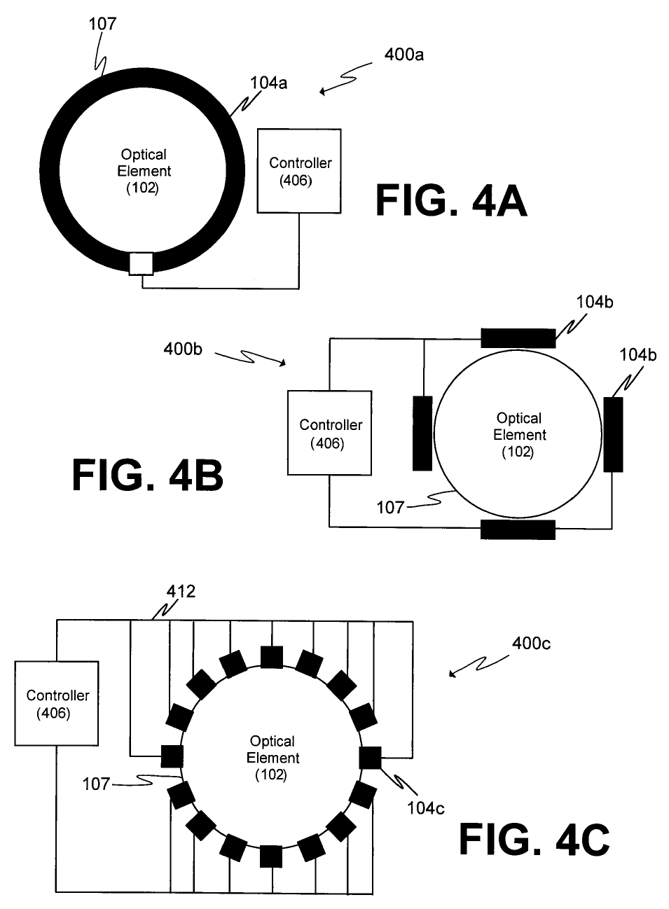

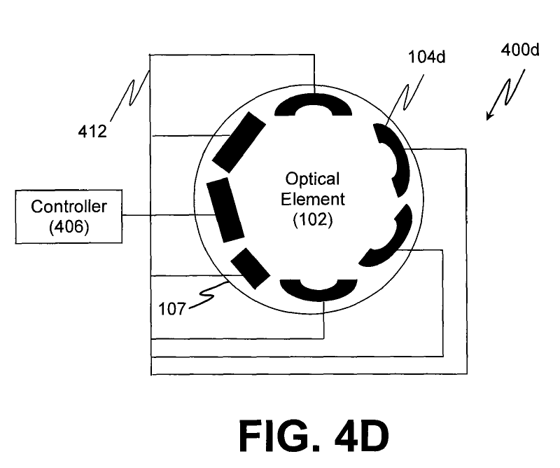

FIGS. 4A-4D show various embodiments of the variable optical configuration 100 including different embodiments of arrangements of the temperature element(s) 104 configured to be controlled by a controller 406. The optical elements 102 have an optical axis that extends substantially perpendicular to the plane of the figures. A laser beam may be directed along the optical axis toward the optical element 102 such that laser beam is directed by the optical element 102. Optical element 102 may be a lens, prism, mirror, or any other optical element configured to effect a change in the laser beam. Although shown in the figures as a circular element, other shapes and configurations are possible depending upon a contemplated embodiment.

Referring to FIG. 4A, shown is a variable optical configuration 100 including one embodiment of an arrangement 400a of the temperature element 104 an optical element 102. As illustrated, the variable optical configuration 400a includes a single temperature element 404a surrounding a periphery 107 of the optical element 102. In some embodiments, the single temperature element 104a is a ring heater. A controller 406 may be operatively coupled to the temperature element 104a so as to control a power input thereto and therefore control a temperature profile of the optical element 102. The symmetric configuration of the temperature element 104a allows primarily a symmetric temperature profile to be generated in the optical element 102.

Referring now to FIG. 4B, shown is another embodiment of an arrangement 400b of the variable optical configuration 100. As illustrated, the arrangement 400b of the variable optical configuration 100 includes an optical element 102 with a temperature element 104, including four temperature elements 104b, provided at cardinal locations on the periphery 107 of the optical element 102. Controller 406 may be operatively coupled to the four temperature elements 104b, so as to control power input thereto. Each temperature element 104b may be controlled independently of the others by the controller 406.

The independent control aspect afforded by the four temperature elements 104b allows for an asymmetric or symmetric temperature profile to be generated. Thus, asymmetry or astigmatism generated in the input laser beam 106 may be compensated by adjustment of the temperature profile of the optical element 102. Conversely, asymmetry may be generated in the output laser beam, as desired, by adjustment of the temperature profile of the optical element 102.

Referring now to FIG. 4C, shown is yet another embodiment of an arrangement 400c of the variable optical configuration 100. As illustrated, the arrangement 400c of the variable optical configuration 100 includes an optical element 102 and a plurality of temperature elements 104c provided at equally spaced locations or, alternatively, at unequally spaced locations (not shown in FIG. 4C) around the periphery 107 of the optical element 102. Controller 406 may be operatively coupled to each temperature element 104c so as to control power input thereto. Each temperature element 104c may be controlled independently of the others by the controller 406. Like the arrangement 400b illustrated in FIG. 4B, the independent control aspect afforded by the individual temperature elements 104c allows for an asymmetric or symmetric temperature profile to be generated. However, the greater concentration of temperature elements 104c around the periphery 107 of the optical element 102 in FIG. 4C, as compared to FIG. 4B, allows for greater precision, variation, and control of the temperature profile of the optical element 102. Thus, asymmetry or astigmatism generated in the input laser beam 106 may be compensated by adjustment of the temperature profile of the optical element 102c. Conversely, customization of the output laser beam, as desired, may be achieved by adjustment of the temperature profile of the optical element 102c.

Referring now to FIG. 4D, shown is yet another embodiment of an arrangement 400d of the variable optical configuration 100. The arrangement 400d illustrated includes an optical element 102 and a plurality of temperature elements 104d. The arrangement 400d illustrated in FIG. 4D includes the capabilities of the embodiment illustrated in FIG. 4C. Additionally, the arrangement 400d illustrated in FIG. 4D provides the temperature elements 104d in closer proximity to the center of the optical element 102. By applying the heating or cooling in closer proximity to the center of the optical element 102, less power is necessary for a given change in the temperature profile and/or the refractive index of the optical element 102. Furthermore, in some embodiments, the temperature elements 104d are both unequally spaced, and placed on the front surface 101 or the back surface 103 of the optical element 102. The controller 406 can be used to adjust the heating and cooling of the temperature elements 104d to shape the laser beam passing through the optical element 102. An asymmetrical application of heating or cooling can be used to convert the laser beam into different shapes.

Regarding FIGS. 1, 2, 3, 4A, 4B, 4C, 4D and 5, the temperature elements 104, 104a, 104b, 104c, and 104d discussed above may include heating elements and/or cooling elements. An example of such a cooling element is the HP-127-1.0-1.3-71 sold by TE TECHNOLOGY™ (Traverse City, Mich.). In the embodiments including a combination of both heating elements and cooling elements, the gradient of the temperature profile of the optical element 102 can be increased.

For embodiments in which the temperature elements 104, 104a, 104b, 104c, and 104d include a heating element, the heating element is a metal layer that is deposited on the barrel of the optical element 102. The metal layer may be Kanthal-A1, nichrome, and/or other similar material. Sealing the metal layer may be particularly useful in embodiments employed in vacuum environments. In some embodiments, the resistance is 25 ohms, and a current of 0.35 A at a voltage of 9V is applied to the heating element. In some embodiments, the heating elements are a small size silicon rubber or polyimide heater affixed to the outer periphery 107 of optical element 102. For example, referring to FIGS. 4B-4D, temperature element 104 can include a small silicone rubber heater, such as heater HK5163R78.4L12A sold by MINCO™ (Minneapolis, Minn.).

In some embodiments, the temperature element 104 includes both a heating element and a temperature measuring device, such as a thermocouple. An example of such a temperature element 104 is the ULTRAMIC™ 600 Advanced Ceramic heater available from WATLOW™ (St. Louis, Mo.). The combination of a heating element with a temperature measuring device allows measurement of the temperature of the optical element 102. Further, in some embodiments, the temperature measuring device provides a control signal for the controller 406.

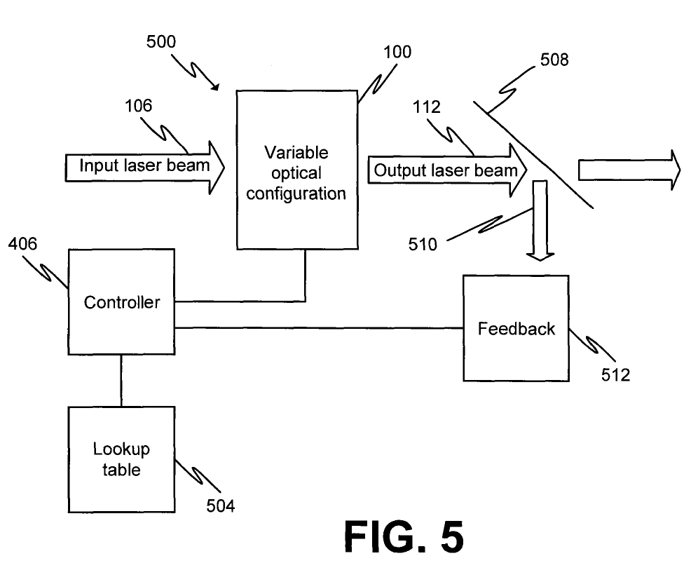

Referring next to FIG. 5, shown is a block diagram of a control system 500 for a variable optical configuration 100 according to one embodiment of the present disclosure. A variable optical configuration 100, as described in detail above, may be provided within or in the vicinity of an input laser beam 106 so as to direct the input laser beam 106. After interaction with the variable optical configuration 100, an output laser beam 112 may be produced. A controller 406 is operatively coupled to the variable optical configuration 100. The controller 406 may use open-loop or closed-loop control methodologies in order to obtain a desired output laser beam 112 from the variable optical configuration 100.

For example, a closed-loop control system 500 may be provided by using a feedback mechanism 512 arranged so as to monitor at least a portion 510 of the output laser beam 112 of the variable optical configuration 100. Portion 510 of the output laser beam 112 may be redirected by optical element 508, such as a beam splitter, dichroic mirror, or the like, to the feedback mechanism 512. The feedback mechanism 512 may include a CCD camera, CMOS camera, or other pixilated detector configured to monitor characteristics of the output beam, such as laser profile or shape. The feedback mechanism 512 may also include discrete intensity detector elements or other known light detection mechanisms. The feedback mechanism may also include temperature measurement of the optical element 102 of the variable optical configuration 100 via thermocouples or one of a variety of other temperature measurement devices. It is further contemplated that the system 500 can be embodied in a free-space optical system, vacuum environment optical system, fiber-optic system or the like.

The controller 406 may receive a feedback signal from the feedback mechanism 512 indicative of characteristics of the output laser beam 112. In other words, the feedback signal is based at least in part upon a portion of the output laser beam 112. The controller 406 may use the signal from the feedback mechanism 512 to control the variable optical configuration 100 to achieve a desired characteristic of the output laser beam 112. Accordingly, the controller 406 may control the temperature element 104 based at least in part on the feedback signal. Such a configuration may thus comprise a positive or negative feedback control mechanism.

Alternately, an open-loop control system 500 may be provided by using previously obtained data. The controller 406 may use data stored in a lookup table 504 to control the variable optical configuration 100 so as to provide a desired output laser beam based on system conditions and inputs. For example, calibration data may be obtained which relates power input for a temperature element 104 of the variable optical configuration 100 to a particular laser beam output for given system conditions (i.e., laser power level, ambient temperature, etc.). This data may be stored in lookup table 504. Subsequently, the controller 406 may recall the stored data from the lookup table 504. Based on system conditions, the controller 406 selects and generates an appropriate power input to the temperature element 104 of the variable optical configuration 100 on the recalled data. The variable optical configuration 100 may thus generate the desired output laser beam 112. The temperature measurement of the optical configuration 100 at one or various positions can also be used to run the controller 406.

It is also noted that in some embodiments, the controller 406 uses both control methodologies. For example, the controller 406 may use data provided by the lookup table 504 to provide a rough or approximate optimization. A feedback signal provided by the feedback mechanism 512 may then be used to provide fine tuning of the output laser beam 112.

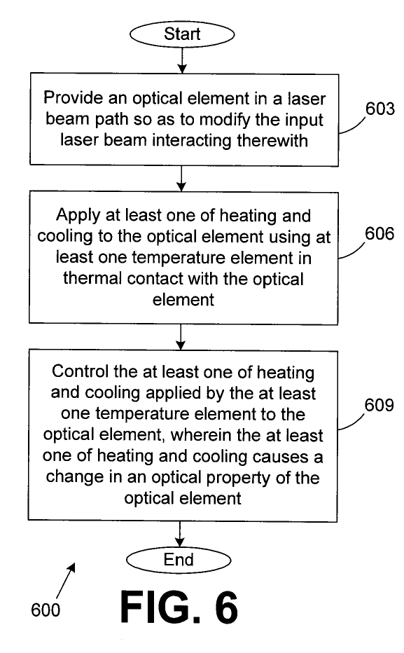

Turning now to FIG. 6, shown is a flowchart that provides one example of a method for adaptively shaping a laser beam. To begin, in box 603, an optical element 102 is provided in a laser beam path so as to modify the laser beam interacting therewith. As discussed above, the optical element 102 may be a reflective optical element 102a or refractive optical element 102b. Also, in some embodiments, the optical element 102 includes a material having a negative thermo-optic coefficient, such as DKDP crystal. Also, in some embodiments, the optical element 102 includes a material has a very high positive thermo-optic coefficient as well as a very large thermal expansion coefficient, such as SF57 glass.

Further, in box 606, at least one of heating and cooling is applied to the optical element 102 is applied using at least one temperature element 104 in thermal contact with the optical element 102. In other words, at least one temperature element 104 conductively heats or cools the optical element 102. In some embodiments, the temperature element 104 not only thermally contacts, but also physically contacts, the temperature element 104. The temperature element 104 is positioned at the periphery 107 of the optical element 102. For example, the temperature element 104 may be arranged around the periphery 107, on the front surface 101, and/or the back surface 103 of the optical element 102. The heating, cooling or a combination of heating/cooling provided by the temperature element 104 to the optical element 102 causes a change in an optical property of the optical element, such as a change in physical surface profile and/or refractive index. These changes thereby modify the laser beam.

Thereafter, in box 609, the conductive heating and/or cooling applied by the temperature element 104 to the optical element 102 is controlled (e.g., tuned) so as to correct the thermal aberrations in the output laser beam 112. The conductive heating and/or cooling is tuned such that the surface temperature profile of the optical element 102 is controlled two-dimensionally (e.g., along an x-axis and/or y-axis) or controlled three dimensionally (e.g., along an x-axis, y-axis, and z-axis,) if a plurality of temperature elements 104 are used on the periphery 107, the front surface 101 and the back surface 103 of the optical element 102. In some embodiments, the controlling is sufficient to minimize thermal aberration effects introduced by other optical elements in the path of input laser beam 106. In some embodiments, the tuning is sufficient to change a focal point of the output laser beam 112. Also, in some embodiments, the tuning is sufficient to change a shape of the output laser beam 112. Further, in some embodiments, the tuning is sufficient to change a wavefront shape of the output laser beam 112.

In some embodiments, the heating and/or cooling applied by the temperature element 104 is controlled by obtaining a feedback signal based at least in part on a portion of the output laser beam 112, which is described in additional detail above with respect to FIG. 5 and the closed-loop control system 500. The control of the temperature element 104, and hence the control of the temperature surface profile of the optical element 102, is based at least in part on the obtained feedback signal. Further, in some embodiments, the heating and/or cooling applied by the temperature element 104 is controlled based at least in part on data (e.g., calibration data) stored in a lookup table, which is discussed in addition detail above with respect to FIG. 5 and the open-loop control system 500.

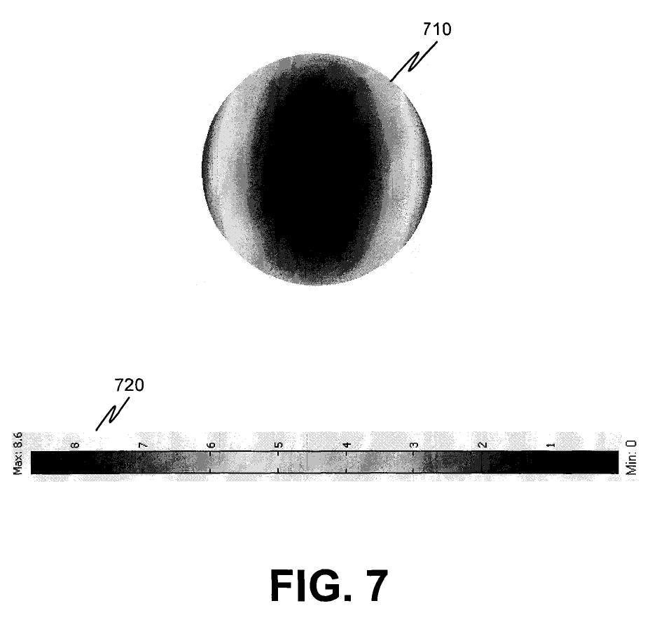

Moving now to FIG. 7, shown is a simulated temperature profile of the optical element 102 of the arrangement 400b of the variable optical configuration 100 in the embodiment illustrated in FIG. 4B. Specifically, FIG. 7 graphically illustrates a simulated temperature profile 710 generated by a finite element analysis along with a color scale 720. The simulated temperature profile 710 is for an optical element 102 being modified by use an embodiment of the variable optical configuration 400b illustrated in the embodiment in FIG. 4B. In the embodiment, the optical element 102 includes a DKDP crystal, and a plurality of temperature elements 104 are in direct physical contact with the optical element 102 and arranged around a periphery 107 thereof. In the embodiment illustrated, temperature elements 104 affixed at diametrically opposite positions heat the optical element 102. As illustrated, a lensing effect of the optical element 102 can be created and controlled.

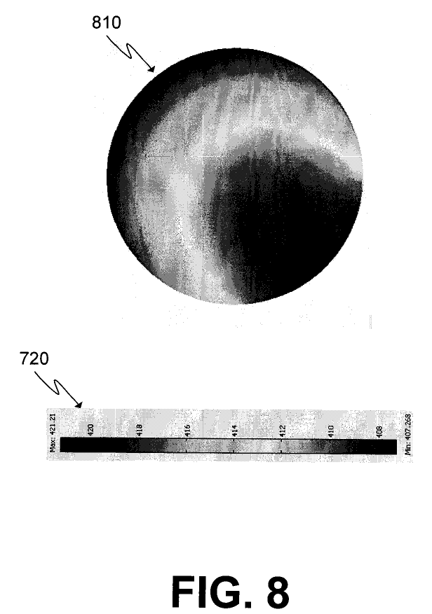

Turning next to FIG. 8, shown is a simulated temperature profile 810 of the optical element 102 of arrangement 400a of the variable optical configuration 100 illustrated in FIG. 4A corresponding to an experiment. In the experiment, an optical element 102 including a 4-mm thick DKDP crystal was placed inside a temperature element 104a, which was a ring heater. Control of the temperature element 104a was realized by ordinary 110 VAC input. Though the temperature element 104a had only one control element, the geometry of the ring heater yielded an astigmatic response. This thermal response is characterized in the finite element simulation 810 with color scale 820 in FIG. 8. The asymmetry is due to a gap in the ring around the optical element 102. Thus, a different thermal lens effect is provided in the horizontal (x) and vertical direction (y). The thermal lensing was measured by using a probe beam at 1064 nm passing through the optical element 102 and by scanning the profile after the beam passes through optical element 102. The beam waist location was tracked to calculate the resultant thermal lens. The resulting data is shown below in Table 1. As is evident from the data, a change in the power applied to the heating element can have a significant impact on the resulting optical properties. The data assumes geometrical optics approximation that an extended source beam is focused at a distance of one focal length distance away from the lens.

TABLE 1
Distance to beam waist in horizontal
and vertical directions based on power applied to
thermal element.

| | |
|---|---|
| | Distance to Beam |
| Power Applied to | Waist (m) |

| Thermal Element (%) | Horizontal | Vertical |
|---|---|---|
| 0 | 1000 | 1000 |
| 10 | 139 | 82 |
| 20 | 92 | 43 |
| 25 | 52 | 33 |

Although certain exemplary embodiments of the present disclosure have been described for use with high-power laser systems (e.g., ≧100 W), aspects of the present disclosure may also be applied to low-power (e.g., <100 W) laser systems as well as non-laser optical systems. It is further noted that aspects of the present disclosure may be applicable to both visible and non-visible wavelengths of the electromagnetic spectrum.

Certain features of the disclosure may sometimes be used to advantage without a corresponding use of other features. While specific embodiments of the disclosure have been shown and described in detail to illustrate the application of the principles of the disclosure, it will be understood that the disclosure may be embodied otherwise without departing from such principles.

It is, therefore, apparent that there is provided, in accordance with the present disclosure, a system and method for laser beam shaping by adaptive optical elements. While this disclosure has been described in conjunction with a number of embodiments, it is evident that many alternatives, modifications, and variations would be or are apparent to those of ordinary skill in the applicable arts. Accordingly, Applicant intends to embrace all such alternatives, modifications, equivalents, and variations that are within the spirit and scope of this disclosure.

1. An adaptive device for shaping of a laser beam comprising:
a variable optical configuration including:
an optical element; and
a temperature element in contact with the optical element; and
a controller operatively coupled to the temperature element, wherein the controller is configured to control the temperature element to apply at least one of heating and cooling to the optical element so as to alter a temperature profile of the optical element, thereby causing a change in an optical property thereof.

2. The adaptive device of claim 1, wherein the temperature element applies heating to the optical element by conduction.

3. The adaptive device of claim 1, wherein the temperature element cools the optical element via thermo-electric means or via vicinity to a cold body.

4. The adaptive device of claim 1, wherein the temperature element physically contacts the optical element at least one of: a periphery of the optical element, a front surface of the optical element, and a back surface of the optical element.

5. The adaptive device of claim 1, wherein the optical element is a reflective optical element, and the change in optical property is a change in a reflective surface profile of the reflective optical element.

6. The adaptive device of claim 5, wherein the optical element includes a metallic substrate having an optical coating positioned thereon.

7. The adaptive device of claim 1, wherein the optical element is a refractive optical element, and the change in the optical property is a change in a refractive index profile of the refractive optical element.

8. The adaptive device of claim 1, wherein the change in the optical property is effective to change at least one of the following: a focal length of the optical element and a shape of the laser beam.

9. The adaptive device of claim 1, further comprising a plurality of temperature elements including the temperature element, the temperature elements being in thermal contact with the optical element, the controller being configured to independently control each of the temperature elements so as to apply at least one of heating and cooling at a plurality of predefined locations on a periphery of the optical element.

10. The adaptive device of claim 9, wherein the controller controls each of the temperature elements such that the optical element has an asymmetric temperature profile.

11. The adaptive device of claim 9, wherein the controller controls the temperature of the temperature elements responsive to measuring the temperature of the optical element.

12. The adaptive device of claim 9, wherein the controller tunes each of the temperature elements such that a desired beam shape for the laser beam is obtained after interacting with the optical element.

13. The adaptive device of claim 1, wherein the optical element is arranged in the beam path of at least one of a high-power laser material processing system and a high-power laser interferometer.

14. The adaptive device of claim 1, further comprising a second optical element arranged in a laser beam path with the optical element, the controller providing power to the heating element such that thermal aberrations are minimized after interacting with both the optical element and the second optical element.

15. The adaptive device of claim 1, wherein the optical element includes a DKDP plate, and the adaptive device further comprises a second optical element including a terbium gallium garnet (TGG) plate.

16. The adaptive device of claim 1, wherein the optical element includes SF57 glass.

17. The adaptive device of claim 1, wherein the temperature elements are arranged at cardinal directions in a plane perpendicular to a beam path through the optical element.

18. The adaptive device of claim 1, wherein the temperature elements are arranged at least one of a periphery of the optical element, a front surface of the optical element, and a back surface of the optical element, the optical element having a three dimensional temperature profile.

19. The adaptive device of claim 1, wherein the temperature element includes one or more of the temperature elements selected from a group consisting of: an electric heater, a ring heater, a ceramic heater, a metal layer coupled to a power source, a polymide heater, a silicone rubber heater, thermoelectric cooler, and a Peltier cooler.

20. The adaptive device of claim 1, wherein the optical element includes a material having a positive or negative thermo-optic coefficient.

21. The adaptive device of claim 1, wherein the optical element includes a material having a positive or negative thermal-expansion coefficient.

22. A method for adaptively shaping a laser beam comprising:
providing an optical element in a laser beam path so as to direct the laser beam passing therethrough;
applying at least one of heating and cooling to the optical element using at least one temperature element in thermal contact with the optical element; and
controlling the at least one of heating and cooling applied by the at least one temperature element to the optical element, wherein the at least one of heating and cooling causes a change in an optical property of the optical element.

23. The method of claim 22, wherein the controlling is sufficient to minimize thermal aberration effects introduced by other optical elements in the laser beam path.

24. The method claim 22, wherein the controlling further includes at least one of measuring and controlling the temperature profile of the optical element.

25. The method of claim 22, wherein the controlling further includes monitoring a property of the laser beam passing through or reflected from the optical element.

26. The method of claim 22, wherein the controlling is sufficient to change at least one of the following: a focal point of the laser beam, a shape of the laser beam, and a wavefront shape of the laser beam.

27. The method claim 22, wherein controlling the at least one of heating and cooling further includes obtaining a feedback signal based at least in part on a portion of an output laser beam directed by the optical element, and wherein controlling the at least one of heating and cooling is based at least in part on the obtained feedback signal.

28. The method of claim 22, wherein controlling the at least one of heating and cooling is based at least in part on calibration data stored in a lookup table.
